(19) United States
(12) Patent Application Publication
(10) Pub. No.: US 2002/0003997 A1
(43) Pub. Date: Jan. 10, 2002

(54) Manipulator/end effector head for robotic assembly

(76) Inventors: William Orinski, Tucson, AZ (US); Kenneth L. Beavers, Tucson, AZ (US); Sven Sedleniek, LaVerne, CA (US)

Correspondence Address: Quarles & Brady Streich Lang LLP, Renaissance One, Two North Central Avenue, Phoenix, AZ, 85004, US

(21) Appl. No.: 09/865,262

(22) Filed: May 25, 2001

Related U.S. Application Data
(60) Provisional application No. 60/207,470, filed on May 25, 2000.

(51) Int. Cl. B66F 1/00

(52) U.S. Cl. 414/590

(57) ABSTRACT

A manipulator head for use in a precision assembly unit is disclosed. The manipulator head includes a coarse X-Y stage or movement along the top surface in the X and Y-axis, a fine X stage for fine X-axis movements, a fine Y stage for fine Y-axis movements, and a Z stage for movement in the Z direction. Additionally, a θ stage carried by the manipulator is included. A video camera is coupled to the fine X stage and fine Y stage. The video camera has an optical axis directed substantially in the Z direction. The video camera's field of view encompassing at least a portion of a part secured by a gripper attached to the manipulator head when the part is in position for processing at the workstation.

### TECHNICAL FIELD OF THE INVENTION

This invention relates to automated assembly equipment and more particularly to a manipulator/end effector head for robotic assembly.

### BACKGROUND OF THE INVENTION

Robotics are commonly used today for the processing and/or assembly of miniature and subminiature assemblies. Robotics are used, amongst other things, to pick up and move parts from a storage area to processing and assembly areas. Robotics can also be used to orient the part and hold it in position for assembly or move the part to an assembly position and help effect assembly of two or more parts to make an assembly. For example, a semi-conductor chip can be taken from a storage area and then placed into a socket on a circuit board after which the chip would be soldered in place on the circuit board. Robotics can move in various directions including X-Y-Z and θ (rotation). As parts to be assembled have become smaller and more complex, the robotics must be more precise in both their ability to pick up and hold a part in a proper position for processing, and also to move the part to a position with greater precision in its placement relative to a processing device or another part to which it is to be joined or otherwise assembled. For many operations, the location accuracy needs to be on the order of about 1 micrometer (μm) (0.00004 inches).

To achieve higher dimensional or location precision, machine vision systems are used to allow viewing of a part and fiducial points accurately positioned on the part so that the vision system can precisely detect and determine the location of the part and points thereon. In one form of machine vision system controlled robot, the vision system views the part that is held stationary and the robot moves another part to it for assembly therewith. After determining the location of the stationary part, the robot then moves the other part into position and assembles the two parts together. However, such a vision system and associated controller assumes the relative position between the two parts while they are some distance apart which is an acceptable method unless the requirements for placement is very stringent. Such a vision system is typically mounted on the side of a robot and moves therewith. After locating the stationary part, the controller then effects movement of the second part to the first part assuming precise relative positions. Such systems can also be used to move a part to be processed from a pick-up station to processing stations, say for example, for the application of glue or other type of liquid thereto and then to an assembly station for subsequent assembly with a stationary part. Such apparatus with associated vision systems have been effective for lower precision work. However, they have not always been as effective as desired for higher precision work. Thus, there is a need for an improved apparatus and method for processing of parts requiring high precision placement for processing.

### SUMMARY OF THE INVENTION

The present invention provides an apparatus for processing miniature and sub-miniature parts using robotics for moving and placing parts. In one aspect of the invention, the apparatus includes an X-Y manipulator for accomplishing the coarse movement of the gripper and the part once gripped. A second device is provided for fine X, Y, Z, and θ movement of the gripper and part carried thereby. A machine vision system is provided that is operable to view the part at a processing station and to provide a signal indicative of the part's location relative to either another part or a processing device and to help guide the part into the proper location by the continued viewing of the part during the final movement or to provide ongoing information about the location such that any assumption regarding part location when the part is not being viewed will cause minimal error with subsequent part movement.

### BRIEF DESCRIPTION OF THE DRAWING

For a more complete understanding of the device and advantages thereof, reference is now made to the following descriptions in which like reference numerals represent like parts:

FIG. 1a is a front elevation view of an apparatus used for robotically moving and assembling parts;

FIG. 1b is an elevation view of the apparatus of FIG. 1;

FIG. 1c is a cutaway overhead view of the apparatus;

FIG. 2 is a partially cutaway view of a manipulator device;

FIG. 3 is a cutaway view of one side of a manipulator device;

FIG. 4 is a cutaway view for a second side of the manipulator device; and

FIG. 5 is an enlarged view of the gripper.

### DETAILED DESCRIPTION OF THE INVENTION

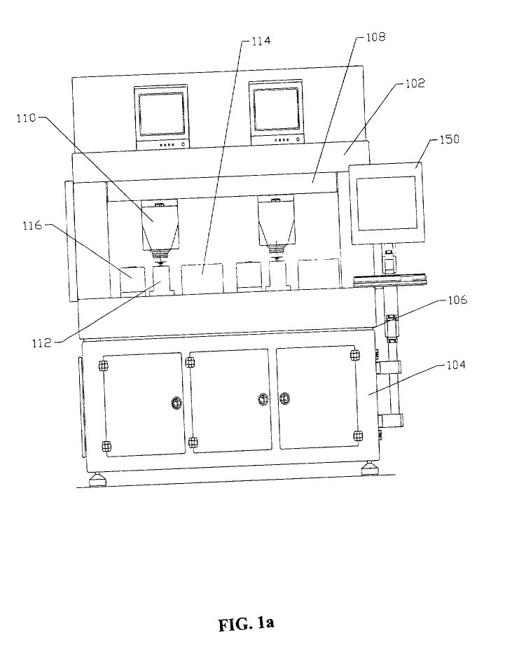

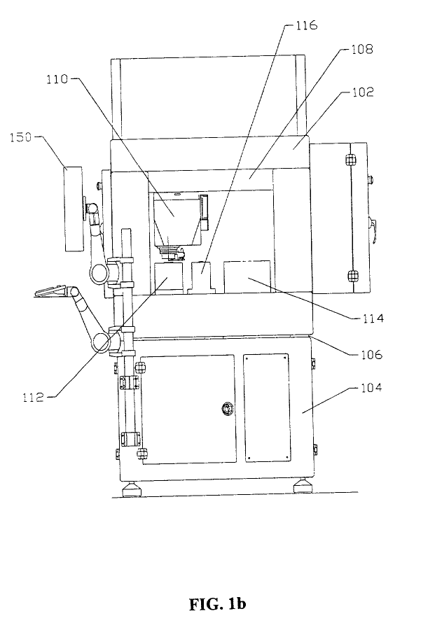

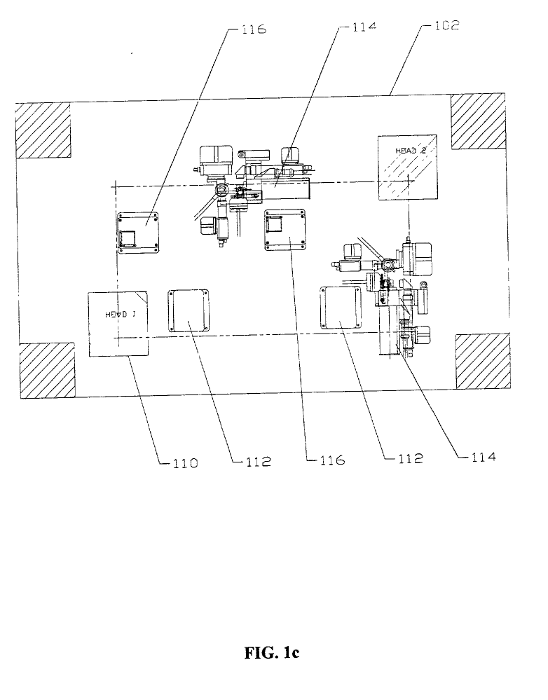

FIG. 1a is a front view of an assembly system 100, FIG. 1b is a side view of assembly system 100 and FIG. 1c is a cutaway overhead view of the assembly system 100. Illustrated in these drawings are an assembly system 100. Assembly system 100 includes a top portion 102 coupled to a base portion 104 using isolation pad 106. Top portion 102 is preferably manufactured from granite. Top portion includes a top surface 102a and a bottom surface 102b. Base portion 104 is preferably manufactured using a welded structural steel. Isolation pad 106 is manufactured from urethane. Top portion 102, base portion 104 and isolation pad 106 together form an assembly system that is extremely rigid and vibration free.

Inside top portion 102 and coupled to a top surface 102a is a robot platen 108. Coupled to robot platen 108 is a manipulator device 110. Robot platen 108 in one embodiment is a steel plate. Manipulator device 110, discussed in further detail below, has magnets distributed about the portion that couples to the steel plate and is able to move about the steel plate. This is accomplished by injecting compressed air between the manipulator device 110 and the robot platen 108. This forms what is commonly known as an air bearing between the manipulator device 110 and robot platen 108.

Inside top portion 102 and coupled to a base plate 102b are a part processing station 114, part assembly station 112, and a part pick up station 116. Adhesive dispense system 114 is operable to apply an adhesive to a work piece and is discussed in further detail in copending application entitled “ADHESIVE DISPENSING AND VISION SYSTEM FOR AN AUTOMATIC ASSEMBLY SYSTEM”, Ser. No.______ and filed May 25, 2001. The disclosure of the co-pending application is incorporated herein by reference.

Part assembly station 112 is an area where an object may be assembled with another. Part pickup station 116 is an area where manipulator device 110 can pick up a part.

Bottom portion 104 provides a rigid support base for top portion 102. Bottom portion 102 also provides an area to place an AC distribution enclosure as well as mount controls and provide various storage areas.

A computer 150 including is provided to control the manipulator device 110, part processing station 114 and other parts of the system 100. Computer 150 can be any general purpose computer, such as a small office computer running the WINDOWS operating system, as sold by Microsoft, Corp. of Redmond, Wash. Computer 150 will typically include a display screen, keyboard, sensor inputs and other input output connections.

In operation, under computer control or, optionally under manual control, manipulator device 110 utilizing the air bearing formed between manipulator device 110 and robot platen 108, will move over to part pickup station 116 where it will get a workpiece. Manipulator device 110 will then move the workpiece to the part assembly station 112 such as an adhesive dispensing system 114. There, the adhesive dispensing system 114 applies adhesive to the workpiece. The manipulator device 110 will then move the work piece to part assembly station 112 where the manipulator device 110 will place the work piece onto a second workpiece while applying force to connect the two workpieces.

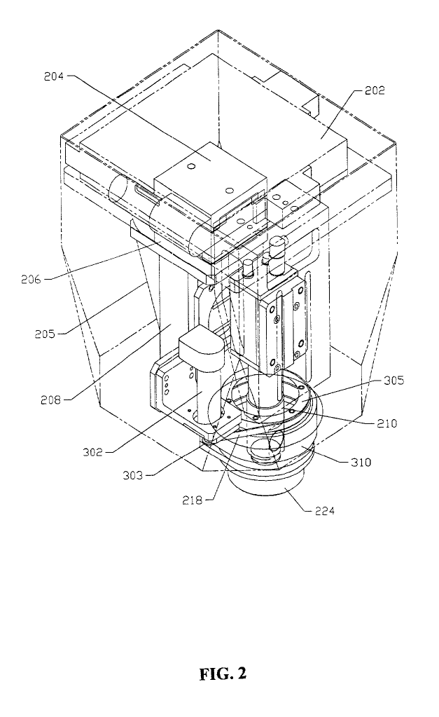

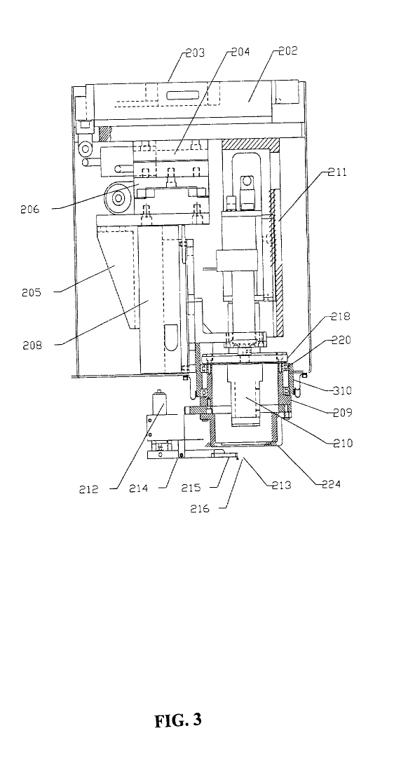

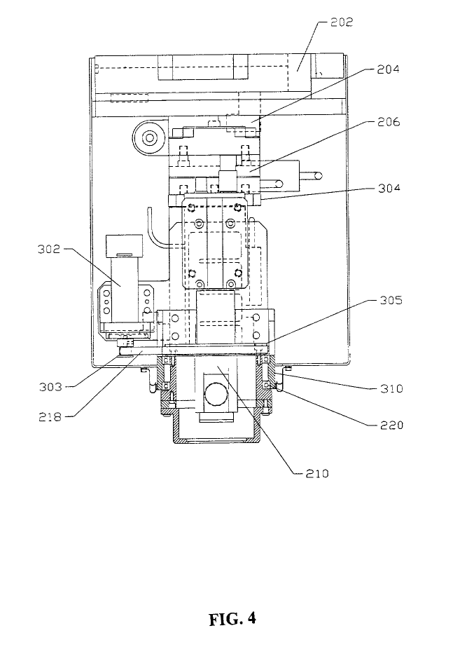

Referring now to FIGS. 2, 3 and 4, FIG. 2 is a partially cutaway isometric view of the manipulator device, FIG. 3 is a cutaway view of the side of the manipulator device and FIG. 4 is a second cutaway side view. As seen in those figures, manipulator device 110 includes a coarse stage 202. In the illustrated structure, the coarse stage 202 utilizes a Normag Dual Axis Linear Stepper Motor Forcer unit (available from NORMAG Corp. of Santa Clarita, Calif.) which is in the form of a planar motor that is magnetically suspended from the robot platen 108. Compressed air is injected between an upper plate 203 of coarse stage 202 and robot platen 108 to provide what is generally referred to as a frictionless air bearing between the upper plate 203 and the platen 108. Coarse stage 202 contains the planar motor which is operable to move the manipulator device 110 in X and Y directions as directed by signals from a controller connected thereto. Coarse stage 202 carries and moves the rest of the manipulator device 110 including the various means for fine movements. Coupled to coarse stage 202 are fine X movement stage 204 and fine Y movement stage 206. The X axis movement is accomplished through the X axis motor 204 while the Y movement is accomplished by the Y axis motor 206. The motors 204, 206 accomplish the fine X-Y movement and encoders can be used with the motors to provide information about the amount of movement and location. The X-Y movement of the fine stage is accomplished through the use of a dual axis positioning system utilizing linear motion motors of high precision such as those available under the name Inchworm from Burleigh Instruments, Inc. of Fishers, N.Y. These motors utilize compact piezoelectric ceramic actuators to achieve ultra-high resolution linear motion positioning.

The motors 204 and 206 are secured to the coarse stage 202 in any suitable manner. A bracket 205 is secured to the Y motor 206 and suspends therefrom. A linear motion motor 208 is mounted on the bracket 205 and is operable to provide the Z axis movement of a pick up head assembly 214 mounted to housing 209 and, which in turn is carried by a bracket 207 which is mounted for movement to the motor 208.

A pick up assembly 214 is carried by the manipulator device 110 and is operable for releasably retaining a workpiece 216. Pick up head assembly 214 is a variable force vacuum pick up head assembly as are known in the art and is pivotally mounted on the manipulator device 110. The force applied to the workpiece 216 by the pick up head assembly 214 engaging the part, is exerted by a voice coil motor 212 to prevent the over application of force to the workpiece 216. Such a pick up head assembly 214 is well known in the art. The workpiece 216 is releasably retained in the pick up head assembly 214 by the application of vacuum to the part and is released from attachment to the pick up device by the release of the vacuum.

θdirection movement of the pick up head assembly 214 and hence a work piece 216 coupled to a gripper portion 215 of the pick up head assembly 214 is accomplished by a servo motor (not seen in FIG. 2) which connects to a housing 209 via a toothed driving belt 218 (sometimes referred to as a gearbelt or a timing belt) that engages a pulley 303 on the servo motor 302 and pulley 305 mounted on the housing 209. The θ direction rotation is in the X-Y plane, generally parallel to the top surface of the top portion 102. Housing 209 is rotatably mounted on a protective shroud 310 via one or more high precision ball bearings 220. The housing 209 is movable in the Z direction via the Z-axis motor as described above. A machine vision system is provided and includes camera 210 mounted on the manipulator device 110 in the housing 209 for movement in at least the X and Y directions. The position of the camera 210 can be adjusted relative to the opening 224 through which the camera 210 views the workpiece 216 for proper focus of the camera on the part and portions of the processing station 114, pickup station 116, and assembly station 112. Alternatively, the pick up head assembly 214 can be moved out of the field of view of camera 210 for viewing just the processing station 114, pick up station 116 and assembly station 112.

The camera 210 can be any suitable machine vision camera, e.g., a video camera, that has the appropriate focal length, field view, correct working distance and depth of field for viewing the workpiece 216 and portions of the processing stations 114 and/or other components. In operation, the camera 210 simultaneously views the workpiece 216 and some element (including a secondary component or part to make an assembly with) at a processing station 114 to provide information to the computer/controller 150. The provided information is analyzed (processed) by the computer/controller 150 which in turn provides control signals to control operation of the manipulator device 110 and hence movement of the workpiece 216 relative to some predetermined point or location at the processing station for processing of the workpiece. The signals generated by the computer/controller 150 are sent to the various elements of the manipulator device 110 for controlling movement of the coarse stage 202 and X motor 204, Y-motor 206 and Z-axis motor 208.

The invention will be better understood by a description of the operation thereof. A workpiece 216 is located at the pick-up station 116. The manipulator device 110 moves the gripper 215 to a location for picking up the workpiece 216. In the particular form of invention illustrated, vacuum is applied through a vacuum tube 213 to the workpiece 216 that then releasably retains the workpiece 216 on the gripper 215. The amount of force applied to the workpiece 216 is monitored by the voice coil motor 212 to insure adequate retention while reducing the risk of damage to the part. The computer/controller 150 is programmed with instructions for movement of the workpiece 216 to the locations at the various subsequent processing stations, for example the stations 114. Coarse (low precision or low resolution) movement of the workpiece 216 is accomplished by the coarse stage 202 of the manipulator under control of the computer/controller 150. When adjacent to a processing station, the camera 210 is operative to simultaneously view both the workpiece 216 and at least a portion of the processing station 114 such as a glue nozzle to determine the relative position between the workpiece 216 and the processing station 114. Fiducial points can be provided both on the workpiece 216 and/or secondary part at the processing station for precisely locating the relative position of the workpiece 216 and the processing station 114. The controller then determines the direction and magnitude of movement required for the workpiece 216 to position it accurately at the processing station 114. After the part is close to the final position, signals are then sent to the fine stage of the manipulator device 110 for movement of the workpiece 216 to the appropriate position relative to the processing station. X, Y, Z and θ movements may be required to appropriately position the workpiece 216 for one or more operations. A fiber optic light source 308 is provided to camera 210 to provide illumination within the field of vision of camera 210.

Preferably the vision system is operable to continuously monitor movement of the workpiece 216 relative to the processing station 114 to ensure proper final location of the workpiece 216. However, it is to be understood that when the workpiece 216 is close to the desired location, the last portion of the movement of the workpiece 216 need not be continuously monitored by the camera 210. However, it has been found desirable to continuously monitor the movement of the part 210 relative to the processing station 114 until the precise relative position has been attained. Continuous monitoring may include some interval breaks in the monitoring during movement to the final position and still provide adequate location precision or the continuous monitoring may have no breaks. The above described movement process is also applicable to moving the workpiece 216 relative to a secondary part positioned for such things as forming an assembly.

An example of an operation that can be performed at the first processing station 20 is the application of one or more spots of adhesive to the part. In this case, the workpiece 216 would be located relative to the adhesive dispensing nozzle at one or more positions on the workpiece for the application of adhesive thereto at predetermined locations on a downwardly facing surface.

An example of a processing step that could be conducted, e.g., at the assembly station 114, is the application of a secondary part or subcomponent, such as an electronic component, to the workpiece 216 by moving the workpiece 216 into engagement with the subcomponent for the adhesive securement of the two together.

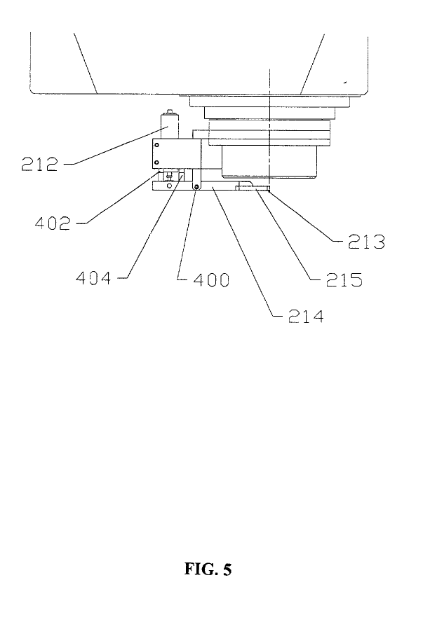

FIG. 5 is a view pick up head assembly 214. Pick up head assembly 214 includes a gripper portion 215, which is operable to hold a workpiece via the application of a vacuum via a vacuum line 213. Voice coil motor 212 applies a force on a workpiece proportional to the current applied to the voice coil motor. A sensor 402 detects very small rotational motion in pick head assembly, which is indicative of the gripper portion 215 contacting a workpiece. A stop 404 limits how far the pick up head assembly can rotate about pivot point 400.

In operation, pick head assembly 214 is mounted to the rest of manipulator device 110. Once it is over a workpiece, it will be lowered in the z-axis. Once the sensor 402 will indicate when the gripper portion contacts the workpiece. Then, if the workpiece is to be moved a vacuum is applied to vacuum line 213 to hold the workpiece. The amount of force exerted on the workpiece is determined by the current applied to the voice coil motor,

In view of the above, it will be seen that several objects of the invention are achieved and other advantageous results attained.

As various changes could be made in the above construction without departing from the scope of the invention, it is intended that all matter contained in the above description and shown in the accompanying drawings shall be interpreted as illustrative and not in a limiting sense.

What is claimed is:

1. An apparatus for precisely placing a part at a workstation of the apparatus, the apparatus comprising:
a frame having a top surface and a bottom surface;
a workstation located between the top surface and the bottom surface;
an manipulator mounted on the top surface comprising;
a coarse X-Y stage for movement along the top surface in the X and Y-axis;
a fine X stage for fine X-axis movements;
a fine Y stage for fine Y-axis movements;
a Z stage coupled to manipulator for movement in the Z direction,
a gripper coupled to the Z stage and moveable in a Z direction by the Z-axis stage and in the X and Y directions by the fine X stage and fine Y stage, the gripper being operable to releasably retain a part to be processed;
a θ stage carried by the manipulator and operably connected to the gripper for selectively moving the gripper in a θ direction; and
a video camera coupled to the fine X stage and fine Y stage having an optical axis directed substantially in the Z direction and directed generally toward the bottom surface, the video camera having a field of view encompassing at least a portion of the part when the part is in position for processing at the work station.

2. The apparatus of claim 1, wherein coarse X-Y movement stage rides along the top surface using a frictionless air bearing.

3. The apparatus of claim 1, wherein the movement of the fine X stage and fine Y stage are effected by an electrically actuated linear motion device.

4. The apparatus of claim 1, further comprising a fiber optic light source operable to provide light in the field of view of the camera.

5. The apparatus of claim 1, further comprising a force sensor connected to the gripper and operable to sense when a force is applied to the part by the gripper.

6. The apparatus of claim 5, further comprising a controller operable to receive input signals from the coarse X-Y stage, the fine X stage, the fine Y stage, the Z stage, the θ stage and the camera and provide output signals to the coarse X-Y stage, Z stage and θ stage to control operations thereof.

7. The apparatus of claim 1, wherein the gripper is attached to a pick-up head assembly, the pick-up assembly coupling the gripper to the z stage.

8. The apparatus of claim 7, wherein the pick-up head assembly further comprises a voice coil motor coupled to the pick-up head assembly, the voice coil motor allowing the pivoting of the pick-up head assembly.

9. The apparatus of claim 8, wherein the pick-up head assembly can be moved out of the field of view of the camera.

10. The apparatus of claim 7, wherein the voice coil motor is operable to exert a force on a workpiece proportional to an input current.

11. The apparatus of claim 1, wherein the gripper is operable to secure a workpiece using a vacuum pick up.

12. A manipulator head for use in a precision assembly unit comprising:
a coarse X-Y stage for movement along the top surface in the X and Y-axis;
a fine X stage for fine X-axis movements;
a fine Y stage for fine Y-axis movements;
a Z stage coupled to manipulator for movement in the Z direction,
a gripper coupled to the Z stage and moveable in a Z direction by the Z-axis stage and in the X and Y directions by the fine X stage and fine Y stage, the gripper being operable to releasably retain a part to be processed;
a θ stage carried by the manipulator and operably connected to the gripper for selectively moving the gripper in a θ direction; and
a video camera coupled to the fine X stage and fine Y stage having an optical axis directed substantially in the Z direction and directed generally toward the bottom surface, the video camera having a field of view encompassing at least a portion of the part when the part is in position for processing at the work station.

13. The manipulator head of claim 12, wherein coarse X-Y movement stage rides along a top surface of a frame using a frictionless air bearing.

14. The manipulator head of claim 12, wherein the movement of the fine X stage and fine Y stage are effected by an electrically actuated linear motion device.

15. The manipulator head of claim 12, further comprising a fiber optic light source operable to provide light in the field of view of the camera.

16. The manipulator head of claim 12, further comprising a force sensor connected to the gripper and operable to sense when a force is applied to the part by the gripper.

17. The manipulator head of claim 12, further comprising a controller operable to receive input signals from the coarse X-Y stage, the fine X stage, the fine Y stage, the Z stage, the θ stage and the camera and provide output signals to the coarse X-Y stage, Z stage and θ stage to control operations thereof.

18. The manipulator head of claim 12, wherein the gripper is attached to a pick-up head assembly, the pick-up assembly coupling the gripper to the z stage.

19. The manipulator head of claim 18, wherein the pick-up head assembly further comprises a voice coil motor coupled to the pick-up head assembly, the voice coil motor allowing the pivoting of the pick-up head assembly.

20. The manipulator head of claim 18, wherein the pick-up head assembly can be moved out of the field of view of the camera.

21. The manipulator head of claim 19, wherein the voice coil motor is operable to exert a force on a workpiece proportional to an input current.

22. The manipulator head of claim 12, wherein the gripper is operable to secure a workpiece using a vacuum pick up.

23. A pick up head assembly for securing a workpiece in an assembly system comprising:
a gripper arm for securing a workpiece using a vacuum;
a vacuum line coupled to the gripper, for supplying a source of a vacuum for the gripper arm; and
a voice coil motor coupled to the gripper arm for pivoting the gripper arm.

24. The pick-up head assembly of claim 23, further comprising a force sensor connected to the gripper and operable to sense when a force is applied to the part by the gripper.

25. The pick-up assembly of claim 23, wherein the voice coil motor is operable to exert a force on a workpiece proportional to an input current.
